(19) United States
(12) Patent Application Publication
(10) Pub. No.: US 2024/0273875 A1
(43) Pub. Date: Aug. 15, 2024

(54) Method for Generating Training Data for an Object for Training an Artificial Intelligence System and Training System

(71) Applicant: Siemens Aktiengesellschaft, Munchen (DE)

(72) Inventors: Matteo Pantano, Munchen (DE); Lucas Janisch, Munchen (DE)

(73) Assignee: Siemens Aktiengesellschaft, Munchen (DE)

(21) Appl. No.: 18/438,579

(22) Filed: Feb. 12, 2024

(30) Foreign Application Priority Data
Feb. 15, 2023 (EP) 23156693.6

(51) Int. Cl. G06V 10/774; G06V 10/778; G06V 10/82

(52) U.S. Cl. CPC G06V 10/774; G06V 10/7788; G06V 10/82

(57) ABSTRACT

Various embodiments of the teachings herein include a method for generating training data for an object for training an artificial intelligence system using a training system. An example method includes: capturing a first image with the object from a first perspective; and capturing a second image with the object from a second perspective; displaying the first image; capturing input of an operator with respect to a position of the object in the first image; determining the object in the first image based on the input; generating a first item of object information based on the determined object; determining the object in the second image based on the determined first item of object information; generating a second item of object information based on the determined object in the second image; and generating training data for the object on the first item of object information and the second item of object information.

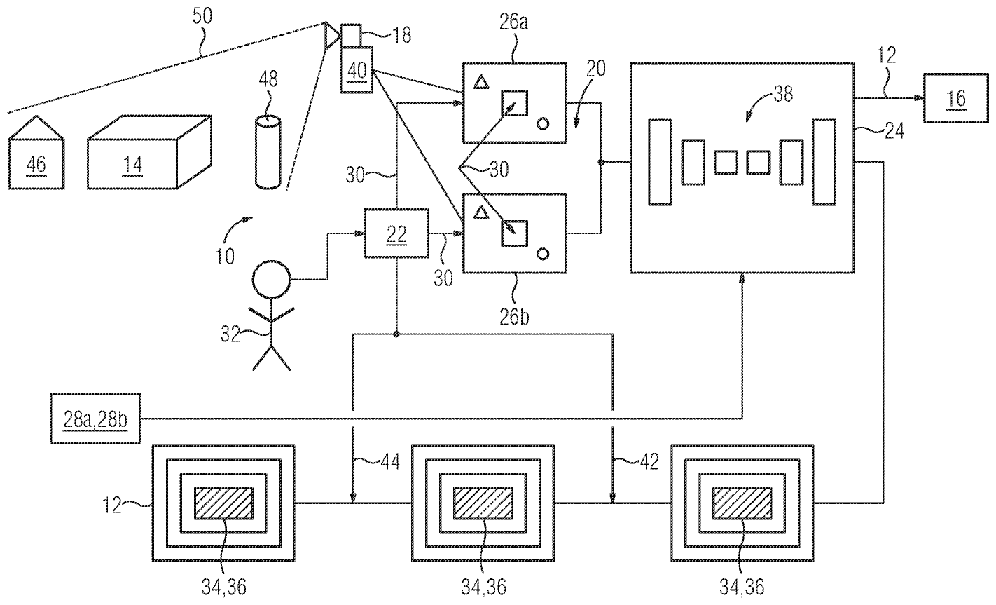

### CROSS-REFERENCE TO RELATED APPLICATIONS

This application claims priority to EP Application No. 23156693.6 filed Feb. 15, 2023, the contents of which are hereby incorporated by reference in their entirety.

### TECHNICAL FIELD

The present disclosure relates to artificial intelligence. Various embodiments of the teachings herein include method and/or systems for generating training data for an object for training an artificial intelligence system.

### BACKGROUND

The training of artificial intelligence (AI) applications requires a dataset with labeled data, for example. In the context of corresponding AI applications that deal with image data, this means that datasets have to be captured and the labeling must be done by human experts. However, this can be a time-consuming and expensive process. There are several tools and methods for solving this problem. The tools can be divided into two classes: labeling tools that require human input or automatic generators for synthetic data.

In the first class, the tools are intended to assist human experts in labeling a plurality of images by using methods for reducing the time it takes to label each image. The best-known example is GrabCut. GrabCut is a tool that can automatically generate a labeled image based on a few points that mark the background and features. This method enables the number of inputs for the labeling to be reduced, thereby shortening the overall labeling time. Similarly, it is also possible to use superpixel approaches to achieve the same results. However, unlike GrabCut, this approach utilizes the generation of small regions that have similar features that a human expert is able to mark.

With the second class, an attempt is made to create labeled data without the need for a human expert. This is achieved by using a synthetic data generator that does not use images from the real-world scenario, but generates images with photorealistic 3D rendering engines in order to generate training images with labeled information.

### SUMMARY

The teachings of the present disclosure include methods, computer program products, computer-readable storage media, and training systems for generating training data for an artificial intelligence system efficiently and effectively for training an artificial intelligence system. For example, some embodiments include a method for generating training data (12) for an object (14) for training an artificial intelligence system (16) by means of a training system (10), including: capturing at least one first image (26a, 26b) with the object (14) from a first perspective (50) and capturing at least one second image (28a, 28b) with the object (14) from a second perspective different from the first perspective (50) by means of a capturing facility (1) of the training system (10); displaying the first image (26a, 26b) on a display facility (20) of the training system (10); capturing an input (30) of an operator (32) of the training system (10) with respect to a position of the object (14) in the displayed first image (26a, 26b) by means of an input facility (22) of the training system (10); determining the object (14) in the first image (26a, 26b) in dependence on the input (30) of the operator (32) by means of an electronic computing facility (24) of the training system (10); generating a first item of object information (34) in dependence on the determined object (14) in the first image (26a, 26b) by means of the electronic computing facility (24); determining the object (14) in the second image (28a, 28b) in dependence on the determined first item of object information (34) by means of the electronic computing facility (24); generating a second item of object information (36) in dependence on the determined object (14) in the second image (28a, 28b) by means of the electronic computing facility (24); and generating training data (12) for the object (14) at least in dependence on the first item of object information (34) and the second item of object information (36) by means of the electronic computing facility (24).

In some embodiments, the first item of object information (34) and/or the second item of object information (36) are generated on the basis of similarities in a surrounding region of the input (30).

In some embodiments, the first item of object information (34) and/or the second item of object information (36) are determined by means of a neural network (38) of the electronic computing facility (24).

In some embodiments, at least the first image (26a, 26b) and/or the second image (28a, 28b) are captured by means of a camera as the capturing facility (18).

In some embodiments, an RYB image (26a, 28a) with the object (14) is captured as the first image (26a, 26b) and/or as the second image (28a, 28b).

In some embodiments, a depth image (26b, 28b) with the object (14) is captured as the first image (26a, 26b) and/or the second image (28a, 28b).

In some embodiments, RYB information from the RYB image (26a, 28a) and depth information from the depth image (26b, 28b) of the first image (26a, 26b) and/or the second image (28a, 28b) are used to determine the first item of object information (34) and/or the second item of object information (36).

In some embodiments, at least the first image (26a, 26b) and the second image (28a, 28b) are captured by means of an automated unit (40) having the capturing facility (18).

In some embodiments, control commands for the automated unit (40) are generated by means of the electronic computing facility (24) so that at least two positions are approached by the automated unit (40) on the basis of the control commands and wherein a respective image (26a, 26b, 28a, 28b) with the object (14) is captured at a respective position.

In some embodiments, the input (30) of the operator (32) is verified by means of a neural network (38).

In some embodiments, before the training data (12) is generated, the first item of object information (34) and/or the second item of object information (36) are displayed to the operator (32) on the display facility (20) for confirmation.

In some embodiments, before the training data (12) is generated, additional further input (44) from the operator (32) with respect to a further position of the object (14) in the first image (26a, 26b) and/or the second image (28a, 28b) is captured.

As another example, some embodiments include a computer program product with program code means which cause an electronic computing facility (24) to perform one or more of the methods as described herein when the program code means are processed by the electronic computing facility (24).

As another example, some embodiments include a computer-readable storage medium with one of the computer program products described herein.

As another example, some embodiments include a training system (10) for generating training data (12) for an object (14) for training an artificial intelligence system (16), with at least one capturing facility (18), one display facility (20), one input facility (22) and one electronic computing facility (24), wherein the training system (10) is embodied to perform one or more of the methods as described herein.

### BRIEF DESCRIPTION OF THE DRAWINGS

The teachings of the present disclosure will now be explained in more detail with reference to exemplary embodiments and with reference to the drawing. Herein, the only FIGURE shows a schematic block diagram of an embodiment of a system for predicting electric current.

The FIGURE shows a schematic block diagram of an example embodiment of a training system incorporating teachings of the present disclosure.

In the FIGURE, identical or functionally identical elements are provided with the same reference symbols.

### DETAILED DESCRIPTION

Some embodiments of the teachings herein include a method for generating training data for an object for training an artificial intelligence system using a training system. At least one first image with the object is captured from a first perspective and at least one second image with the object is captured from a second perspective different from the first perspective by a capturing facility of the training system. The first image is displayed on a display facility of the training system. An input of an operator of the training system with respect to a position of the object in the displayed first image is captured by means of an input facility of the training system. The object in the first image is determined in dependence on the input of the operator by means of an electronic computing facility of the training system. A first item of object information is generated in dependence on the determined object in the first image by means of the electronic computing facility. The object in the second image is determined in dependence on the determined first item of object information. A second item of object information is generated in dependence on the determined object t in the second image by means of the electronic computing facility and training data for the object is generated at least in dependence on the first item of object information and the second item of object information by means of the electronic computing facility. This allows the use of real captured images without corresponding CAD models for training the artificial intelligence system. In addition, the training system makes direct use of the operator's expert knowledge which accordingly ensures the confidentiality of the data and replicates the real application as closely as possible.

Some embodiments address the deficiency of typical solutions; although a synthetic approach can generate high-quality data, this in particular requires a CAD model of the object or part and does not generate any corresponding data equivalent to a real application. On the other hand, although the manual generation of data or the labeling of data that corresponds most closely to the real application is possible, the labeled data can in particular be faulty and it is very time-consuming to generate. Therefore, the example embodiment above includes a hybrid method that uses the advantages of both methods, i.e., in particular data from the real world and high-quality error-free labeling, and eliminates the need for CAD files for the object.

In some embodiments, a plurality of images is captured and a plurality of items of object information are generated. Then, the plurality of images and items of object information are in turn evaluated accordingly in dependence on the first item of object information. The proposed masked regions for a respective image are examined from a different perspective of the object and can, for example, be displayed to a user accordingly and thus lead to the evaluation.

In some embodiments, the first item of object information and/or the second item of object information are generated on the basis of similarities in a surrounding region of the input. In particular, a search for similarities in regions close to the position of the input is examined. In some embodiments, a surface of the object can serve as an item of object information. In other words, the image is examined for similarities around the position of the input. This makes it possible to establish that, for example, a point around the input point also belongs to the object, for example the surface of the object. Thus, this enables the first item of object information and the second item of object information to be captured reliably. This is in particular referred to as masking.

In some embodiments, the first item of object information and/or the second item of object information are determined by means of a neural network of the electronic computing facility. The neural network is in particular a decoder and an encoder. In particular, it can, for example, be provided that the point of the input is defined in the three-dimensional world and is mapped onto the image space by the projection. The input by the operator, which can in particular be regarded as an initial assumption, is then taken over and evaluated accordingly by the neural network. Thus, the item of object information can be generated effectively and efficiently.

In some embodiments, at least the first image and/or the second image are captured by means of a camera as the capturing facility. In particular, the camera accordingly captures a plurality of images. Thus, on the basis of the camera, corresponding images can be recorded and the images can be evaluated efficiently and effectively for the generation of the training data.

In some embodiments, the first image and/or second image are captured as an RYB image with the object. In some embodiments, the first image and/or second image are captured as a depth image with the object. In addition, it can be provided that RYB information from the RYB image and depth information from the depth image of the first image and/or the second image are used to determine the first item of object information and/or the second item of object information. The RYB image is in particular a so-called red-yellow-blue image. Thus, in particular, the object to be captured is recorded via the camera, which in turn can generate a respective 2D RYB image and the depth image of the real-world environment. Herein, the images in both the RYB image and the depth image have the objects or the object. Accordingly, a plurality of images are recorded from different perspectives by means of the camera so that a complete dataset is created. The RYB images and the depth images can be used as the basis for fine-tuning the position of the operator's or user's initial assumption accordingly, so that the input is again located on the part of the image in which the object is also located.

In some embodiments, at least the first image and the second image are captured by means of an automated unit comprising the capturing facility. In some embodiments, the first image and the second image, in particular the plurality of images, to be generated in an automated manner. This enables the automated, and thus time-saving, generation of training data.

In some embodiments, control commands for the automated unit are generated by means of the electronic computing facility so that at least two positions are approached by the automated unit on the basis of the control commands and wherein a respective image with the object is captured at a respective position. In particular the two positions are selected in such a way that they enable different perspectives onto the object. In particular, a plurality of positions can be approached accordingly on the basis of the control commands. Accordingly, this enables the method to be performed in an automated manner. For example, the automated unit can be a robot that has the camera. The automated robot can, for example, be embodied as ground-based or also as a drone.

In some embodiments, the input of the operator is verified by means of a neural network. In particular, the point in the 3D world is defined by the projection onto the image space. This input by the operator, which herein only corresponds to a first assumption, is then in turn taken over by the neural network, which uses the RYB image and the depth image to fine-tune the position of the first assumption such that it lies on the part of the image in which the object is located. This step is performed because the user input could be inaccurate for the first assumption. The corrected point is then taken over by another algorithm, which, by searching for similarities in regions close to the corrected original assumption, proposes a corresponding region or mask in which the object is located.

In some embodiments, before the training data is generated, the first item of object information and the second item of object information are displayed to the operator on the display facility for confirmation. In other words, the proposed and masked region determined by the electronic computing facility is displayed to the operator accordingly. Herein, the operator in turn receives feedback on the corresponding quality of the segmentation in order to subsequently change this region by inputting additional positions, for example in the three-dimensional world. Finally, this feedback is returned to the segmentation algorithm or the electronic computing facility and the sequence of operations is repeated until an additional further user input describing the completion of the method takes place. For example, this user input can in turn only be captured when the user or the operator is also satisfied with the corresponding segmentation.

In some embodiments, before the training data is generated, a further input of the operator with respect to a further position of the object in the first image and/or the second image is captured. Thus, the electronic computing facility or the neural network can be trained in a highly effective manner, thereby allowing the training data to be generated efficiently and effectively.

In some embodiments, the methods are in particular a computer-implemented method. Therefore, some embodiments include a computer program product with program code means which cause an electronic computing facility to perform one or more methods as described herein when the program code means are processed by the electronic computing facility. Some embodiments include a computer-readable storage medium with at least the computer program product.

Some embodiments include a training system for generating training data for an object for training an artificial intelligence system, with at least one capturing facility, one display facility, one input facility and one electronic computing facility, wherein the training system is embodied to perform one or more of the methods described herein. In particular, the method may be performed by the training system.

In some embodiments, the electronic computing facility includes at least one neural network. Furthermore, the electronic computing facility has at least processors, circuits, in particular integrated circuits, and further electronic components in order to be able to perform corresponding method elements.

Various embodiments of the method are to be regarded as embodiments of the computer program product, the computer-readable storage medium, and the training system. The training system has substantive features to perform corresponding method elements. For cases or situations that could arise during the method and which are not explicitly described here, it can be provided according to the method that an error message and/or a request for the input of user feedback is output and/or a default setting and/or a predetermined initial state is set.

Independent of the grammatical term usage, individuals with male, female or other gender identities are included within the term.

Further features of the teachings herein emerge from the claims, the FIGURE, and the description of the FIGURE. The features and feature combinations mentioned above in the description and the features and feature combinations mentioned below in the description of the FIGURE and/or shown in the FIGURE alone can be used not only in the respectively disclosed combination, but also in other combinations without departing from the scope of the invention.

The FIGURE shows a schematic block diagram of an example embodiment of a training system 10 incorporating teachings of the present disclosure. The training system 10 generates training data 12 for an object 14 for training an artificial intelligence system 16. The training system 10 has at least one capturing facility 18, one display facility 20, one input facility 22 and one electronic computing facility 24.

In particular, the FIGURE shows a so-called pipeline of a hybrid mode for generating the training data 12, in particular the pipeline by means of which the corresponding training data 12 can be generated. In particular, at least one first image 26a, 26b with the object 14 is captured from a first perspective and at least one second image 28a, 28b with the object 14 is captured from a second perspective different from the first perspective by means of the capturing facility 18, which in the present case is in particular depicted as a camera. An input 30 of an operator 32 with respect to a position of the object 14 in the displayed first image 26a, 26b is captured by means of the input facility 22.

In particular, a position of the input 30, hereinafter in particular represented as a point, on the object 14 is captured. The object 14 in the first image 26a, 26b is determined in dependence on the input 30 of the operator 32 by means of the electronic computing facility 24. A first item of object information 34 is determined in dependence on the determined object 14 in the first image 26a, 26b by means of the electronic computing facility 24. The object 14 in the second image 28a, 28b is determined in dependence on the determined first item of object information 34. A second item of object information 36 is determined in dependence on the determined object 14 in the second image 28a, 28b by means of the electronic computing facility 24 and the training data 12 for the object 14 is generated at least in dependence on the first item of object information 34 and the second item of object information 36.

In some embodiments, the first item of object information 34 and/or the second item of object information 36 are generated on the basis of similarities in a surrounding region of the input 30. The first item of object information 34 and/or the second item of object information 36 may be determined by a neural network 38, for example in the form of a decoder and an encoder, of the electronic computing facility 24.

In some embodiments, an RYB image 26a, 28a with the object 14 is captured as the first image 26a, 26b and/or as the second image 28a, 28b. Moreover, it is in particular provided that a depth image 26b, 28b with the object 14 is captured as the first image 26a, 26b and/or as the second image 28a, 28b. Herein, it is in particular provided that RYB information from the RYB image 26a, 28a and depth information from the depth image 26b, 28b of the first image 26a, 26b and/or the second image 28a, 28b are used to determine the first item of object information 34 and/or a second item of object information 36.

Furthermore, the FIGURE shows that at least the first image 26a, 26b and the second image 28a, 28b are captured by means of an automated unit 40, for example by means of a robot, having the capturing facility 18. In some embodiments, control commands for the automated unit 40 are generated by means of the electronic computing facility 24, so that at least two positions are approached by the automated unit 40 on the basis of the control commands and wherein a respective image 26a, 26b, 28a, 28b with the object 14 is captured at a respective position.

In some embodiments, the input of the operator 32 is verified by means of the neural network 38. In some embodiments, before the training data 12 is generated, the first item of object information 34 and the second item of object information 36 are displayed to the operator 32 on the display facility 20 for confirmation; in the present case this is shown by a further input 42. In some embodiments, before the training data 12 is generated, additional further input 44 of the operator 32 with respect to a further position of the object 14 in the first image 26a, 26b and/or the second image 28a, 28b is captured.

The FIGURE shows a hybrid method that uses data from the real world and uses high-quality error-free labeling and eliminates the need for CAD files for the object 14. First, the objects to be captured 14, 46, 48, or the object 14, are recorded via a camera mounted on a robot, which records a two-dimensional RYB image 26a, 28a and a depth image 26b, 28b of the real-world environment including the objects 14, 46, 48 of interest or the object 14. The robot moves with the camera around the object 14 and a plurality of images 26a, 26b, 28a, 28b are recorded so that a complete dataset is created.

Then, the training system 10 prompts the operator 32 to point to the object 14 to be captured and give the object 14 a name, for example. This point is defined in the three-dimensional world and embodied by a projection onto the image space. In particular, this is depicted by the input 30. Herein, this input 30 merely corresponds to a first assumption and is taken over by the neural network 38, which uses the RYB images 26a, 28a and the depth images 26b, 28b to fine-tune the position of the first assumption such that it lies on the object 14 of the image in which the object 14 is located. Herein, this step is provided because the input 30 could be inaccurate for the first assumption.

The corrected point is then taken over by another algorithm which, by searching for similarities in regions close to the corrected original assumption, proposes a region or mask in which the object 14 is located. In particular, this corresponds to the first item of object information 34 or the second item of object information 36. This takes place for an image of each angle of the object 14 so that the proposed masked regions can be displayed to the operator 32 again. Herein, the operator 32 receives feedback on the quality of the segmentation in order to subsequently modify the region by inputting additional positions in the three-dimensional world. Finally, this feedback is returned to the segmentation algorithm and the sequence of operations is repeated until the operator 32 is satisfied and the training data 12 can be forwarded to the artificial intelligence system 16.

### LIST OF REFERENCE SYMBOLS

10 Training system
12 Training data
14 Object
16 Artificial intelligence system
18 Capturing facility
20 Display facility
22 Input facility
24 Electronic computing facility
26a RYB image
26b Depth image
28a RYB image
28b Depth image
30 Input
32 Operator
34 First item of object information
36 Second item of object information
38 Neural network
40 Automated unit
42 Further input
44 Additional further input
46 Further object
48 Additional further object

1. A method for generating training data for an object for training an artificial intelligence system using a training system, the method comprising:
capturing a first image with the object from a first perspective; and
capturing a second image with the object from a second perspective different from the first perspective using a capturing facility associated with the training system;
displaying the first image on a display facility of the training system;
capturing input of an operator of the training system with respect to a position of the object in the displayed first image by an input facility of the training system;
determining the object in the first image based at least in part on the input using an electronic computing facility of the training system;
generating a first item of object information based on the determined object in the first image using the electronic computing facility;
determining the object in the second image based at least in part on the determined first item of object information by the electronic computing facility;
generating a second item of object information based at least in part on the determined object in the second image by the electronic computing facility; and
generating training data for the object at least in part on the first item of object information and the second item of object information by the electronic computing facility.

2. The method as claimed in claim 1, wherein the first item of object information and/or the second item of object information are generated on the basis of similarities in a surrounding region of the input.

3. The method as claimed in claim 1, wherein the first item of object information and/or the second item of object information are determined by a neural network of the electronic computing facility.

4. The method as claimed in claim 1, wherein at least the first image and/or the second image are captured by a camera as the capturing facility.

5. The method as claimed in claim 1, wherein an RYB image with the object is captured as the first image and/or as the second image.

6. The method as claimed in claim 1, wherein a depth image with the object is captured as the first image and/or the second image.

7. The method as claimed in claim 1, wherein:
an RYB image with the object is captured as the first image and/or as the second image and a depth image with the object is captured as the first image and/or the second image; and
RYB information from the RYB image and depth information from the depth image are used to determine the first item of object information and/or the second item of object information.

8. The method as claimed in claim 1, wherein the first image and the second image are captured by an automated unit having the capturing facility.

9. The method as claimed in claim 8, further comprising generating control commands for the automated unit bythe electronic computing facility so that at least two positions are approached by the automated unit on the basis of the control commands; and
wherein a respective image with the object is captured at a respective position.

10. The method as claimed in claim 1, further comprising verifying the input of the operator by a neural network.

11. The method as claimed in claim 1, further comprising, before generating the training data, displaying the first item of object information and/or the second item of object information to the operator on the display facility for confirmation.

12. The method as claimed in claim 1, further comprising, before generating the training data, capturing additional further input from the operator with respect to a further position of the object in the first image and/or the second image.

13. A training system for generating training data for an object for training an artificial intelligence system, the system comprising:
a capturing facility to: capture a first image with the object from a first perspective using the, and capture a second image with the object from a second perspective different from the first perspective;
a display facility to display the first image on a display facility of the training system;
an input facility to capture input of an operator of the training system with respect to a position of the object in the displayed first image; and
an electronic computing facility to: determine the object in the first image based at least in part on the input using an electronic computing facility of the training system, generate a first item of object information based on the determined object in the first image, determine the object in the second image based at least in part on the determined first item of object information, generate a second item of object information based at least in part on the determined object in the second image, and generate training data for the object at least in part on the first item of object information and the second item of object information by the electronic computing facility.
